(19) United States
(12) Patent Application Publication
(10) Pub. No.: US 2010/0239083 A1
(43) Pub. Date: Sep. 23, 2010

(54) Method for restricting and remotely configuring call forwarding services

(76) Inventor: Sanjeev Mahajan, Naperville, IL (US)

Correspondence Address: Alcatel-Lucent;Docket Administrator, Room 2F-192, 600-700 Mountain Ave., Murray Hill, NJ, 07974-0636, US

(21) Appl. No.: 12/383,100

(22) Filed: Mar. 19, 2009

(51) Int. Cl. H04M 3/42

(52) U.S. Cl. 379/211.02

(57) ABSTRACT

The present invention provides a method for restricting and remotely configuring call forwarding service in wireless or wireline communication systems. An originating switch receives a call request from a calling communication unit. The call request includes an indication that the caller does not want this call to be forwarded if the called communication unit has activated the call forwarding option. The call is routed to the directory number of the called communication unit, not the call forwarding number of the called communication unit.

### FIELD OF THE INVENTION

The present invention relates generally to communication systems, and more particularly to the call forwarding feature in wireline and wireless communication systems.

### BACKGROUND OF THE INVENTION

Call forwarding is a feature in wireline and wireless communication systems that allows a user to forward incoming calls to their phone to a phone number that is different than the directory number of their phone. The call forwarding feature is activated and deactivated by entering predetermined keys on the phone that is desiring calls to be forwarded.

One problem with call forwarding is that it requires the user to activate and deactivate the feature from the phone that is being forwarded. This can be a problem if you are away from your home and you realize that you have entered an incorrect forwarding number. Another problem can occur if you would like to change the forwarding number while away from home, such as when you are traveling to multiple destinations.

Another problem with the call forwarding feature is that there are times when a caller does not want their call forwarded. For example, a caller may know that a person is away from home and may want to leave a message on that user's voicemail rather than forward the call request to the user. There is currently no method to override the call forwarding feature by a caller.

Therefore, a need exists for a method of allowing greater flexibility of call forwarding for both the subscriber and any callers to the subscriber.

### BRIEF SUMMARY OF THE INVENTION

The present invention provides a solution to the problems associated with the prior art. In accordance with an exemplary embodiment of the present invention, network support is provided for call forward restriction at an originating switch. In an exemplary embodiment, a called phone has requested call forwarding of calls to its directory number but a caller does not want the current call request to be forwarded. In accordance with this exemplary embodiment, the call request includes an indication, such as a predetermined feature code, that the caller does not want the call request to be forwarded if the called party has activated the call forwarding feature.

If the call request includes a call forwarding override feature code, the originating switch associated with the calling phone knows from the feature code that the calling phone does not want the call request to be forwarded. The originating switch sets a call forwarding restriction bit to ON and continues with processing this call request.

If the call request does not include a call forwarding override feature code, the network continues with normal call processing.

In this manner, this exemplary embodiment provides a caller with the ability to override call forwarding if the called party has activated the call forwarding feature. This allows the caller, for example, to connect with the called phone's voicemail if the caller simply wants to leave a voicemail message rather than connect directly with the called party.

When a call request does not feature a call forwarding feature override code, a terminating switch that receives a call request determines if a call forwarding restriction bit is ON in the call request. If the call forwarding restriction bit is ON, the terminating switch disables call forwarding for the current call. The terminating switch then continues with call processing by routing the call to the directory number of the called phone, not the forwarded number that the called phone selected when activating the call forwarding feature.

If the call forwarding restriction bit is not ON, the terminating switch continues with call processing by routing the call to the call forwarding number of the called phone that the called when it activated the call forwarding feature.

An exemplary embodiment of the present invention also provides support for a call forwarding cancel feature. A communication unit that has activated the call forwarding feature can dial in to the terminating switch and modify the call forwarding feature. For example, the user can dial the directory number of his or her phone and, prior to being forwarded, enter a feature code that alerts the terminating switch that the caller does not want to be connected to the called phone but rather wants to make changes to the call forwarding feature.

In accordance with an exemplary embodiment, a caller can dial their own phone number and enter a feature code prior to call completion. The terminating switch would then offer an options menu to the caller. This options menu could include options related to call forwarding, such as the ability to remotely deactivate call forwarding and the ability to change the call forwarding number remotely, from a phone that is not the phone that activated the call forwarding feature.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flowchart of network support for call forward restriction at an originating switch in accordance with an exemplary embodiment of the present invention.

FIG. 3 depicts a flowchart of network support for call forward restriction at a terminating switch in accordance with an exemplary embodiment of the present invention.

FIG. 4 depicts a flowchart of network support for a call forwarding cancel feature in accordance with an exemplary embodiment of the present invention.

FIG. 5 depicts a flowchart of network support for remote call forwarding and activation in accordance with an exemplary embodiment of the present invention.

### DETAILED DESCRIPTION OF THE INVENTION

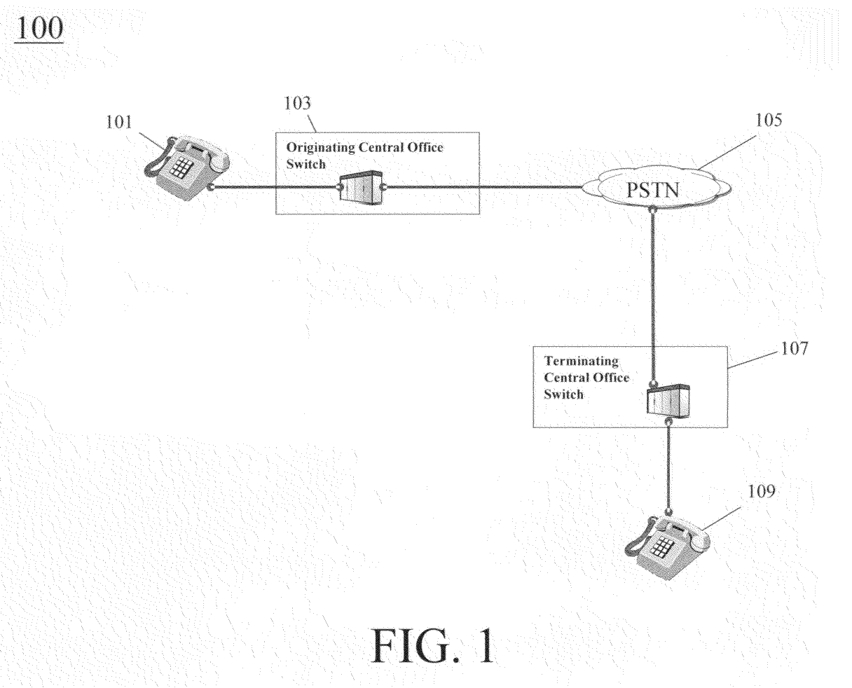

The present invention can be better understood with reference to FIGS. 1 through 5. FIG. 1 depicts a portion 100 of a communication system in accordance with an exemplary embodiment of the present invention. Portion 100 includes calling communication unit 101, an originating central office switch 103, PSTN 105, a terminating central office switch 107, and called communication unit 109.

Calling communication unit 101 can be a wireline or wireless phone.

Originating central office switch 103 is a system of components that connects telephone calls to and from PSTN 105. In the exemplary embodiment where the calling communication unit is a wireless phone, switch 103 is a wireless communication system that includes, for example, sufficient wireless network equipment to facilitate calls to and from other wireless and wireline phones.

PSTN 105 is an international telephone network that provides telephony service to users connected to PSTN 105. PSTN 105 provides the ability for landline users to place and receive calls within the communication system.

Terminating central office switch 107 is substantially similar to originating central office switch 103.

Called communication unit 109 can be a wireline or wireless phone.

In accordance with the exemplary embodiment depicted in FIG. 1, calling communication unit 101 places a call to call communication unit 109. In this exemplary embodiment, called communication unit 109 has activated a call forwarding feature so that call requests placed to the directory number of called communication unit 109 are routed to the number chosen by called communication unit when it activated the call forwarding service.

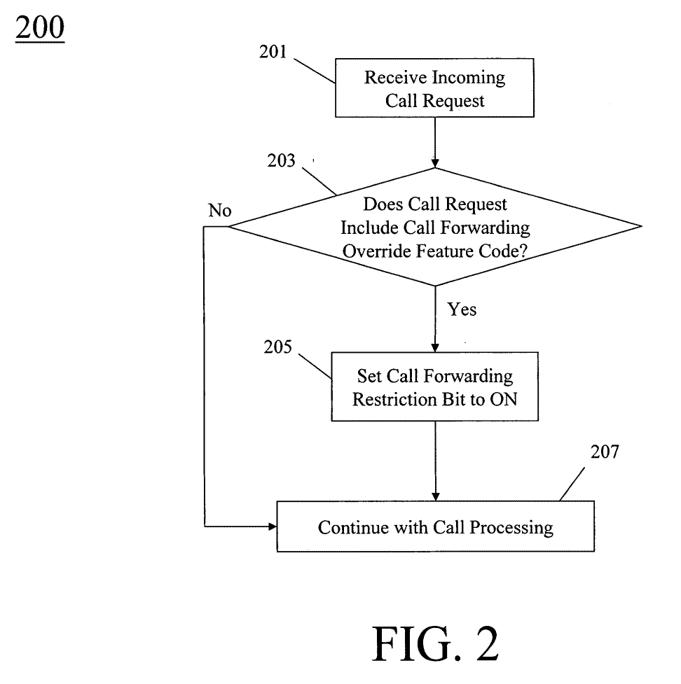

FIG. 2 depicts a flowchart 200 of network support for call forward restriction at an originating switch in accordance with an exemplary embodiment of the present invention. In the exemplary embodiment depicted in FIG. 2, the called phone has requested call forwarding of calls to its directory number but the caller does not want the current call request to be forwarded.

The network receives (201) an incoming call request. In an exemplary embodiment, the called phone has requested the call forwarding feature, although the present invention works if the called phone has not activated the call forwarding feature. In accordance with this exemplary embodiment, the call request includes an indication, such as a predetermined feature code, that the caller does not want the call request to be forwarded if the called party has activated the call forwarding feature.

The originating switch determines (203) if the call request includes a call forwarding override feature code. In an exemplary embodiment, the caller presses a predetermined feature code, such as *88, prior to dialing the phone number of the called phone. The originating switch associated with the calling phone receives this key sequence and knows from the feature code that the calling phone does not want the call request to be forwarded if the called phone has activated the call forwarding feature.

If the call request includes a call forwarding override feature code, the originating switch sets (205) a call forwarding restriction bit to ON. In an exemplary embodiment, the originating switch sets a bit in an ISUP IAM message. The network then continues (207) with processing this call request.

If the call request does not include a call forwarding override feature code as determined in step 203, the network continues (207) with normal call processing.

In this manner, this exemplary embodiment provides a caller with the ability to override call forwarding if the called party has activated the call forwarding feature. This allows the caller, for example, to connect with the called phone's voicemail if the caller simply wants to leave a voicemail message rather than connect directly with the called party.

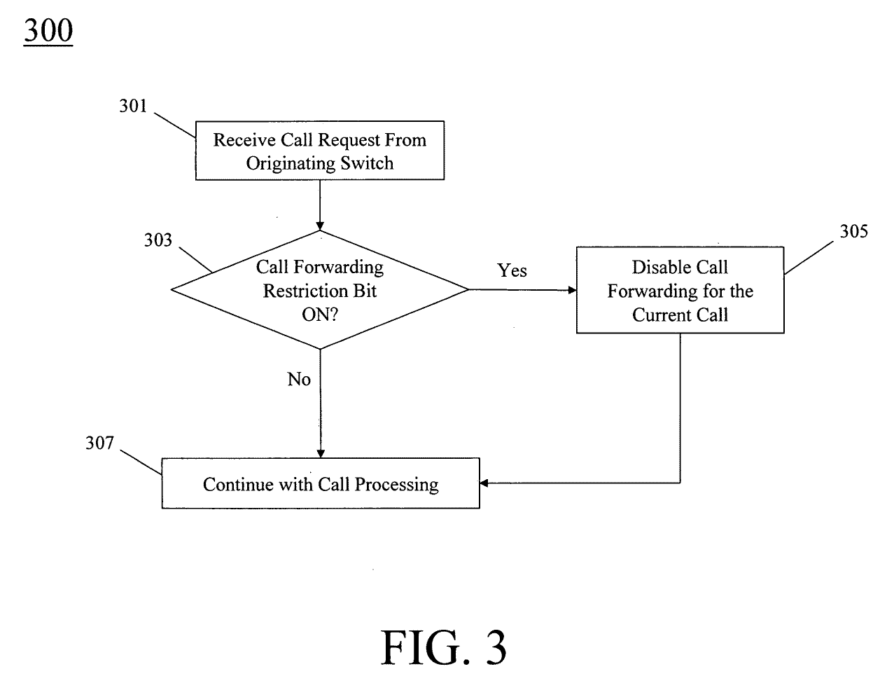

FIG. 3 depicts a flowchart 300 of network support for call forward restriction at a terminating switch in accordance with an exemplary embodiment of the present invention. In this exemplary embodiment, a terminating switch is receiving a call request that includes a call forwarding restriction feature code, as was depicted in FIG. 2.

A terminating switch receives (301) a call request from an originating switch. The terminating switch is a central office switch that is currently connected with the called phone in wireline systems. In the exemplary embodiment when the called phone is a mobile phone, the terminating switch is an MSC to which the called phone is currently registered.

The terminating switch determines (303) if the call forwarding restriction bit is ON in the call request. If the call forwarding restriction bit is ON, the terminating switch disables (305) call forwarding for the current call. The terminating switch then continues (307) with call processing by routing the call to the directory number of the called phone, not the forwarded number that the called phone selected when activating the call forwarding feature.

If the call forwarding restriction bit is not ON, the terminating switch continues (307) with call processing by routing the call to the call forwarding number of the called phone that the called when it activated the call forwarding feature.

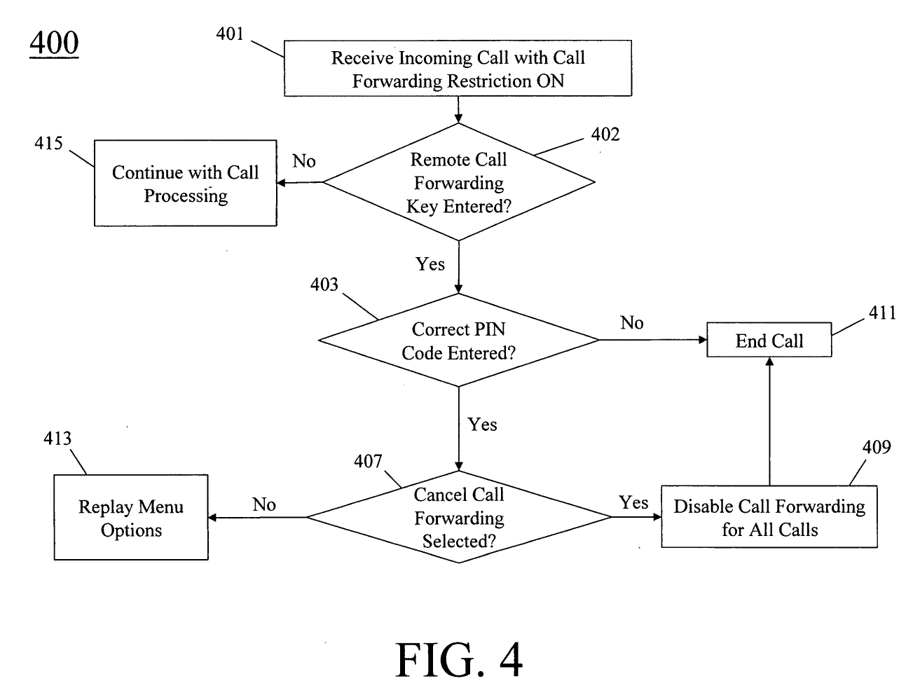

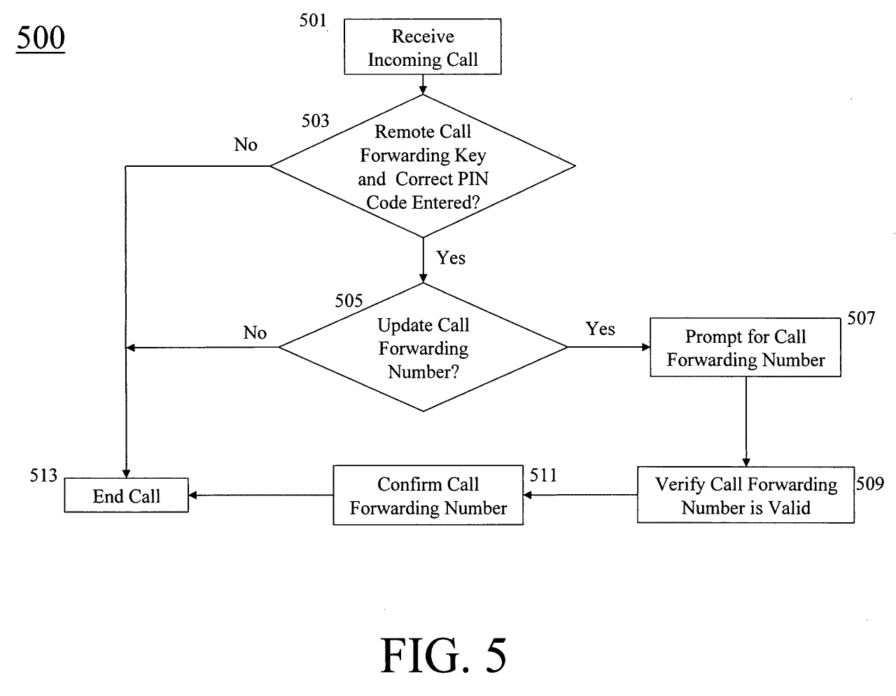

FIG. 4 depicts a flowchart 400 of network support for a call forwarding cancel feature in accordance with an exemplary embodiment of the present invention. For the exemplary embodiment depicted in FIGS. 4 and 5, the communication unit that has activated the call forwarding feature can dial in to the terminating switch and modify the call forwarding feature. For example, the user can dial the directory number of his or her phone and, prior to being forwarded, enter a feature code that alerts the terminating switch that the caller does not want to be connected to the called phone but rather wants to make changes to the call forwarding feature.

In the exemplary embodiment depicted in FIG. 4, the terminating switch receives (401) an incoming call request, for example from an originating switch.

The terminating switch determines (402) if a remote call forwarding key was entered. In an exemplary embodiment, the call forwarding key is a feature code, sometimes referred to as a star code. If the remote call forwarding key was not entered, the terminating continues (415) with call processing for the call. In an exemplary embodiment, the switch alerts a line. In an alternate exemplary embodiment the caller can be redirected to an options menu.

If a remote call forwarding key was entered as determined at step 402, the terminating switch determines (403) if a correct PIN code was entered. If the correct PIN code was not entered, the terminating switch ends (411) the call, although in an alternate exemplary embodiment the caller can be redirected to an options menu.

If the correct remote call forwarding key and PIN code were entered at steps 402 and 403, the terminating switch determines (407) if the caller selected a cancel call forwarding option. If the caller selected the cancel call forwarding option, the terminating switch disables (409) call forwarding for all calls to the calling phone.

The terminating switch then preferably ends (411) the call, although in an alternate exemplary embodiment the caller can be directed back to the menu from which the user selected the option to cancel call forwarding.

If the caller does not select the cancel call forwarding option at step 407, the terminating switch preferably replays (413) the menu to allow the caller to choose an option from the menu.

FIG. 5 depicts a flowchart 500 of network support for remote call forwarding and activation in accordance with an exemplary embodiment of the present invention. As indicated above, the caller can dial their own phone number and enter a feature code prior to call completion. The terminating switch would then offer an options menu to the caller. This options menu could include options related to call forwarding, such as the ability to remotely deactivate call forwarding and the ability to change the call forwarding number remotely, from a phone that is not the phone that activated the call forwarding feature.

The terminating switch receives (501) an incoming call intended for a phone serviced by the terminating switch.

The terminating switch determines (503) if a remote call forwarding key was entered. If the remote call forwarding key was not entered, the terminating switch continues (515) with call processing. For example, the terminating switch can provide alert line treatment to the call request.

If a remote call forwarding key was entered at step 503, the terminating switch determines (504) if a correct PIN code was entered. If the correct PIN code was not entered, the terminating switch ends (513) the call. Ending the call may comprise directing the caller to an options menu.

If the correct PIN code was entered at step 504, the terminating switch determines (505) if the caller specified an option to change the call forwarding number. If the caller did not select the new call forwarding number option, the terminating switch replays (517) a menu of options for the caller.

If the correct call forwarding key and PIN were entered at step 503 and an update call forwarding number option was selected at step 505, the terminating switch prompts (507) the caller for a new call forwarding number.

After receiving the new call forwarding number from the caller, the terminating switch verifies (509) that the newly entered call forwarding number is valid.

The terminating switch confirms (511) the call forwarding number and then preferably ends (513) the call.

While this invention has been described in terms of certain examples thereof, it is not intended that it be limited to the above description, but rather only to the extent set forth in the claims that follow.

I claim:

1. A method for restricting call forwarding services, the method comprising:
receiving a call request at an originating switch for a called communication unit from a calling communication unit, the call request including a bypass call forwarding indication, the called communication unit having a directory number and a forwarding number that the called communication unit has requested all calls be forwarded to; and
routing the call request from the calling communication unit to the directory number of the called communication unit.

2. A method for restricting call forwarding services in accordance with claim 1, wherein the bypass call forwarding indication comprises a feature code.

3. A method for restricting call forwarding services in accordance with claim 2, wherein the feature code is a star code.

4. A method for restricting call forwarding services in accordance with claim 1, the method further comprising the step of setting a call forwarding restriction bit upon receiving the bypass call forwarding indication.

5. A method for restricting call forwarding services in accordance with claim 1, wherein the step of routing the call request from the calling communication unit to the directory number of the called communication unit comprises disabling call forwarding for the duration of the call.

6. A method for remotely configuring call forwarding services, the method comprising:
receiving a request to deactivate a call forwarding service for a first communication unit, the request coming from a second communication unit that is different from the first communication unit; and
deactivating the call forwarding service for the first communication unit.

7. A method for remotely configuring call forwarding services in accordance with claim 6, the method further comprising the step of, prior to deactivating the call forwarding service, verifying that the second communication unit is permitted to deactivate the call forwarding service.

8. A method for remotely configuring call forwarding services in accordance with claim 7, wherein the step of verifying that the second communication unit is permitted to deactivate the call forwarding service comprises receiving a remote call forwarding key.

9. A method for remotely configuring call forwarding services in accordance with claim 7, wherein the step of verifying that the second communication unit is permitted to deactivate the call forwarding service comprises receiving a PIN that matches a stored PIN.

10. A method for remotely configuring call forwarding services, the method comprising:
receiving a request to update a call forwarding number for a first communication unit, the request coming from a second communication unit that is different from the first communication unit and including an updated call forwarding number; and
changing the call forwarding number for the first communication to the updated call forwarding number.

11. A method for remotely configuring call forwarding services in accordance with claim 10, the method further comprising the step of, prior to changing the call forwarding number, verifying that the second communication unit is permitted to update the call forwarding service.

12. A method for remotely configuring call forwarding services in accordance with claim 10, the method further comprising the step of verifying that the updated call forwarding number is a valid telephone number.
